(19) United States
(12) Patent Application Publication
(10) Pub. No.: US 2008/0317924 A1
(43) Pub. Date: Dec. 25, 2008

(54) Beverage and Method of Making Same

(75) Inventor: Angel Yang, Bellevue, WA (US)

Correspondence Address: KNOBBE MARTENS OLSON & BEAR LLP, 2040 MAIN STREET, FOURTEENTH FLOOR, IRVINE, CA, 92614, US

(73) Assignee: Starbucks Corporation, Seattle, WA (US)

(21) Appl. No.: 12/138,316

(22) Filed: Jun. 12, 2008

Related U.S. Application Data
(60) Provisional application No. 60/945,692, filed on Jun. 22, 2007.

(51) Int. Cl. C11B 5/00; A23C 23/00; A23F 5/00; B65B 3/04; A23C 13/12; A23F 3/00

(52) U.S. Cl. 426/541; 426/580; 426/594; 426/597; 426/586; 141/9

(57) ABSTRACT

The present embodiments are directed to beverages such as ready-to-drink coffee and tea beverages. A beverage in accordance with the embodiments described herein includes at least two discrete, preprepared and packaged components. In some embodiments, one of the components is a coffee or tea base, and another component is a dairy or soy base. During final processing, the two or more discrete bases are combined together with water and packaged for sale as a ready-to-drink beverage.

### CROSS-REFERENCE TO RELATED APPLICATIONS

This application claims priority under 35 U.S.C. § 119(e) to U.S. Provisional Application No. 60/945,692 filed Jun. 22, 2007, which is hereby incorporated by reference in its entirety.

### BACKGROUND

1. Field

The present embodiments generally relate to beverages such as ready-to-drink coffee and tea beverages and methods of making the same.

2. Description of the Related Art

Ready-to-drink, prepackaged coffee and tea beverages are currently being sold in the United States, Europe, and Asia, including, for example, iced coffee and other coffee/milk beverages. Currently sold ready-to-drink coffee and tea beverages tend to undergo some separation when stored in warmer temperatures, for example, the cream portion of the beverage container tends to float to the top of the beverage and proteins tend to coagulate on the bottom of the beverage container. Therefore, there exists a need for ready-to-drink beverages having components and recipes that are designed to have a longer shelf life in warmer climates than currently sold ready-to-drink beverages.

### SUMMARY

Some embodiments relate to a method of making a beverage, comprising: (1) providing at least two premade discrete base components, wherein at least one base component comprises a coffee or tea base component and at least one other component comprises a dairy or soy base component; wherein each component comprises at least one of a buffering, emulsifying, or stabilizing agent independently and prepared at a first location; (2) combining the at least two base components with water to make a ready-to-drink beverage at a second location; and (3) processing and packaging the finished beverage.

In some embodiments, at least one of the premade base components is buffered with at least one buffering agent, e.g. disodium phosphate, potassium citrate, potassium carbonate, and the like.

In some embodiments, the disodium phosphate is present in at least one of the premade components at an amount of about 0.1 to about 1 percent by weight.

In some embodiments, the potassium citrate is present in at least one of the premade components at an amount of about 0.1 to about 1 percent by weight.

In some embodiments, at least one premade component comprises at least one selected from the group consisting of dietary fiber, a vitamin, an omega-3 oils, a fruit extract, an antioxidant, a flavinoid, lycopene, selenium, a beta-carotene, resveratrol, a vegetable extract, and a herbal extracts.

In some embodiments, the at least two premade base components are prepared at least 12 hours before being combined.

In some embodiments, the at least two premade base components are prepared at least 1 week before being combined.

In some embodiments, the beverage comprises water in an amount of about 80 to about 90 percent by weight, a coffee or tea base component in an amount of about 0.5 to about 10 percent by weight, a dairy or soy base component in an amount of about 1 to about 60 percent by weight, and a flavor key in an amount of about 0.05 to about 5 percent by weight.

In some embodiments, the coffee or tea base component includes an encapsulated coffee or tea extract.

In some embodiments, the dairy or soy base component includes a dairy or soy dispersion and a cream mix.

In some embodiments, the beverage is a ready-to-drink beverage.

In some embodiments at least one premade component comprises at least one selected from the group consisting of dietary fiber, a vitamin, an omega-3 oils, a fruit extract, an antioxidant, a flavinoid, lycopene, selenium, a beta-carotene, resveratrol, a vegetable extract, and a herbal extracts

Some embodiments relate to a method of making a beverage, comprising: (1) providing at least two premade discrete base components, wherein at least one base component comprises a coffee or tea base component; wherein each component is buffered independently and prepared at a first location; and (2) combining the at least two base components to make a beverage at a second location.

In some embodiments, the at least two premade base components are prepared at least 12 hours before being combined with water.

In some embodiments, the at least two premade base components are prepared at least 3 days before being combined with water.

In some embodiments, the beverage comprises water in an amount of about 65 to about 95 percent by weight, a coffee or tea base component in an amount of about 0.5 to about 10 percent by weight, a dairy or soy base component in an amount of about 1 to about 60 percent by weight, and a flavor key in an amount of about 1 to about 3 percent by weight.

In some embodiments, the coffee or tea base component includes an encapsulated coffee or tea extract.

In some embodiments, the dairy or soy base component includes a dairy or soy dispersion and a cream mix.

In some embodiments, the beverage is a ready-to-drink beverage.

In some embodiments, at least one premade component comprises at least one selected from the group consisting of dietary fiber, a vitamin, an omega-3 oils, a fruit extract, an antioxidant, a flavinoid, lycopene, selenium, a beta-carotene, resveratrol, a vegetable extract, and a herbal extracts.

In some embodiments, at least one of the components is buffered with at least one of disodium phosphate or potassium citrate.

In some embodiments, the disodium phosphate is present in at least one of the base components at an amount of about 0.1 to about 1 percent by weight.

In some embodiments, the potassium citrate is present in at least one of the base components at an amount of about 0.1 to about 1 percent by weight.

### BRIEF DESCRIPTION OF THE DRAWINGS

FIG. 1 is a process flow diagram illustrating an overview of one embodiment of a method of making a beverage.

### DETAILED DESCRIPTION

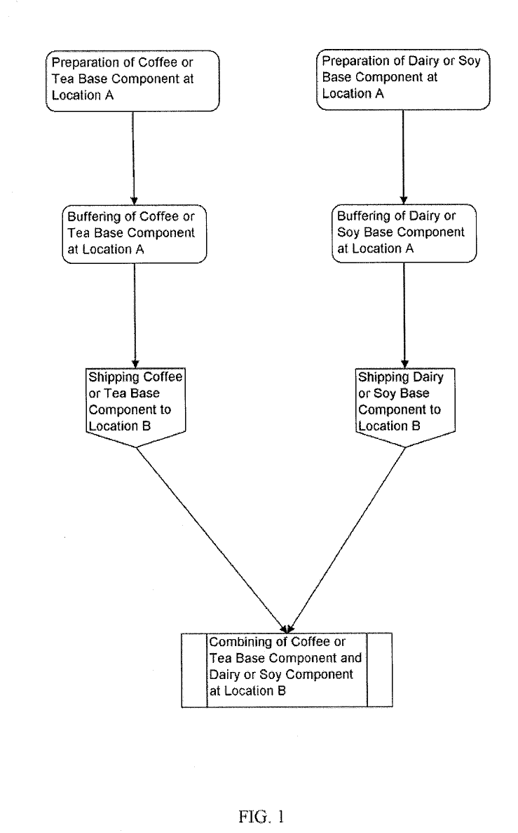

Embodiments of the present disclosure are directed to beverages such as ready-to-drink coffee and tea beverages. A beverage in accordance with the embodiments described herein includes at least two discrete, preprepared and packaged components. In some embodiments, one of the components is a coffee or tea base, and another component is a dairy or soy base. During final processing, the two or more discrete bases are combined together with water, processed, and packaged for sale as a beverage. FIG. 1 shows a flow diagram of an exemplary embodiment for a method of making a beverage.

The discrete base components and the resulting ready-to-drink products are designed to have improved shelf life in warmer ambient conditions, for example, in tropical, arid, semiarid, temperate, and mesothermal climates. In that regard, the discrete base components can be prepared for packaging and shipment to another facility for final mixing and preparation of the end product. As a nonlimiting example, the discrete base components can be prepared and packaged in the United States, and then shipped to other countries for processing and packaging for sale as a ready-to-drink beverage. Some of the advantages of combining a plurality of preprepared and packaged base components include the following: allowance for final product variation, for example, by the addition of more of one base product in the final product to appeal to the tastes of a specific country or region; increased shelf-life stability for the discrete base components; and the ability to maintain the exact recipe of the discrete bases as a secret, if desired.

In some embodiments, the two separate components are prepared individually at different locations and shipped to another location where they are combined at least about 12 hours later. In other embodiments three or more separate components are prepared individually or together in one location and then shipped to another location at least about 12 hours later. In some embodiments the separate components are combined about 24 hours after being prepared. In some embodiments the separate components are combined about 48 hours after being prepared. In some embodiments the separate components are combined about 3 days after being prepared. In some embodiments the separate components are combined about 1 week after being prepared. In some embodiments the separate components are combined about 1 month after being prepared. In some embodiments the separate components are combined about 6 months after being prepared. In some embodiments the separate components are combined about 1 year after being prepared.

In some embodiments, additional ingredients can be included in one, some or all of the prepared components such as fiber or other health and wellness compounds such as vitamins, omega-3 oils, fruit extracts, antioxidants, flavinoids, lycopene, selenium, beta-carotene, resveratrol, vegetable extracts, herbal extracts, etc. In some embodiments, these additional ingredients can aid in the encapsulation of a coffee/tea base or a dairy/soy base or any other component of the beverage.

In one embodiment, the coffee/tea base is prepared using the following ingredients: (1) water in an amount of about 40 to about 70 percent by weight; and (2) ground coffee or tea in an amount of about 20 to about 40 percent by weight. The water is added to a mixing tank. The coffee or tea is ground to a fine-particle size for efficient extraction and is extracted in the mixing tank. The resulting extract is then filtered and concentrated to a predetermined solids level.

The resulting coffee or tea extract can be encapsulated to preserve aroma and flavor. In some embodiments, a buffering agent, such as potassium citrate, is added to the mixing tank in an amount of about 0.2 to about 0.5 percent by weight and heated to about 120 F. Sugar may be added in an amount of about 0.1 to about 5 percent by weight, and an encapsulation agent, such as whey protein or maltodextrin, is added in an amount of about 5 to about 20 percent by weight. A high-shear mixer can be used to disperse the sugar and the encapsulation agent in the extract. The resulting encapsulated coffee/tea base may be dried using a conventional drying process, such as spray drying, vacuum drying, freeze drying, etc. The coffee/tea base can then be packaged, stored, and/or shipped for later combination with the dairy/soy base.

In some embodiments, concentrated soluble coffee solids may be provided in the form of a soluble powder or liquid base coffee concentrate. In one embodiment, a coffee concentrate is a concentrated extract of coffee beans, roasted or raw. The coffee extract may be obtained by extracting raw or roasted coffee beans with a solvent. Methods for extracting roasted coffee beans and for concentrating the resulting extract are well known in the art. Any suitable extraction procedure or concentration procedure may be used. The choice and design of the extraction procedure and concentration procedure is a matter of preference.

In some embodiments, the concentrated coffee solids may be subjected to enzymatic hydrolysis; for example using a gamanase. Hydrolysis using a gamanase offers the advantage of increased stability and a further reduction in sedimentation.

The concentrated dairy components may be provided in the form of a powdered milk or a suitable milk concentrate. The milk concentrate may be prepared by any means available to those skilled in the art. For example, the milk concentrate may be prepared by the procedure commonly used to produce aseptically processed, evaporated, or condensed milk. Alternatively, the milk concentrate may be prepared by concentrating milk, for example, by evaporation. The solution of milk concentrate, having the selected solids content, may also be prepared by combining skimmed milk solids, milk fat, and sugar with water. Optionally, additional milk protein sources such as whey or casein may be added. If a milk concentrate is used, the milk concentrate may have a milk solids content above about 20% by weight. Preferably, the milk concentrate has a solids concentration of between about 50% by weight and 85% by weight.

Coffee aromas are the volatile components of coffee that produce the characteristic fragrance of coffee. In some embodiments, the coffee aroma is provided in the form of a highly aromatized coffee concentrate. The aromatized coffee concentrate is prepared by adding coffee aroma to a coffee concentrate. Methods of preparing coffee concentrates are well known in the art.

The coffee aroma is in the form of natural coffee aroma components that are collected during the preparation of soluble coffee powder. In some embodiments, the natural coffee aroma includes highly volatile aroma components. Highly volatile aroma components are those which condense at a temperature below about 0 degrees C. To recover highly volatile aroma components, volatile aroma components may be flushed from the coffee during processing using an inert carrier gas such as nitrogen. The aroma-laden carrier gas is then chilled to temperatures lower than about −40 degrees C., and sometimes as low as about −195 degrees C., to cause the aroma components to condense. The condensed aroma components are then collected. Suitable procedures for capturing coffee aroma are disclosed in, for example, U.S. Pat. Nos. 3,823,241, 5,030,473, and 5,222,364, the disclosures of which are expressly incorporated herein by reference in their entirety.

In some embodiments, sufficient coffee aroma is added to one or more of the components in the form of, for example, aromatized concentrate.

In some embodiments the coffee/tea base described above may be prepared in accordance with any variation commonly known for coffee and/or tea products, including, but not limited to, caffeinated, decaffeinated, sweetened, unsweetened, flavored, etc.

In some embodiments, the dairy/soy base includes a dairy/soy dispersion and a cream mix, which are then combined to form the dairy/soy base. The dairy/soy dispersion is generally prepared using the following ingredients: (1) water in an amount of about 5 to about 90 percent by weight; (2) a buffering agent (nonlimiting examples including disodium phosphate, potassium citrate, etc.) in an amount of about 0.1 to about 2.0 percent by weight; (3) milk or soy (nonlimiting examples including nonfat milk solids (NFMS), soy isolate, etc.) in an amount of about 5 to about 10 percent by weight; and (4) a stabilizer (nonlimiting examples including pectin, carbomethylcellulose (CMC), alginate, guar gum, etc). Water is added to a mixing tank, and the buffering agent is added to the water to adjust pH to neutral or slightly alkaline. The milk or soy are added, using a high-shear mixer to disperse the protein ingredients. The stabilizer, which is generally premixed with sugar, is dispersed into the mixture also using the high-shear mixer.

In some embodiments, the separate cream mix is prepared using the following ingredients: (1) sweet cream in an amount of about 3 to about 10 percent by weight; (2) vegetable oil (nonlimiting examples including coconut butter, palm kernel oil, etc.) in an amount of about 2 to about 5 percent by weight; and (3) emulsifier (nonlimiting examples including sodium laurel sulfate, monoglyceride, diglyceride, etc.) in an amount of about 0.1 to about 0.5 percent by weight. The sweet cream is added to a mixing tank. Vegetable oil is added to the sweet cream and the resulting mixture is heated to about 120 degrees F. Emulsifier is then dispersed into the mixture using the high-shear mixer.

In some embodiments, the dairy/soy base is a combination of the dairy/soy dispersion and the cream mix, and further includes flavorings (nonlimiting examples including vanilla, caramel, hazelnut, orange, etc.), salt, spices (nonlimiting examples including cinnamon, nutmeg, cardamom, etc.), sweetener, (nonlimiting examples including sugar, honey, sucralose, stevia, and non-nutritive sweeteners, etc.), corn syrup solids, and/or maltodextrin, all of which can be combined in the mixing tank. Similar to the coffee/tea base, the resulting dairy/soy base may be dried using a conventional drying process, such as spray drying, vacuuming drying, freeze drying, etc. The dairy/soy base can then be packaged, stored, and/or shipped for later combination with the coffee/tea base.

Some embodiments relate to a resulting ready-to-drink beverage that includes the following ingredients: (1) water in an amount of about 80 to about 90 percent by weight; (2) the encapsulated coffee or tea base in an amount of about 0.5 to about 10 percent by weight; (3) the dairy or soy base in an amount of about 5 to about 10 percent by weight; and (4) a flavor key in an amount of about 0.1 to about 5 percent by weight. The coffee or tea base is mixed with the water in a mixing tank using a high-shear mixer to reconstitute the coffee or tea extract. The dairy or soy base and the flavor key are then mixed into the mixing tank using a high-shear mixer. After the ready-to-drink beverage is homogenized, the beverage is commercially sterilized via ultra-high temperature (UHT) or high temperature, short time (HTST) pasteurization techniques, using aseptic packaging equipment or retort to produce a shelf stable ready-to-drink beverage.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A method of making a beverage, comprising:
providing at least two premade discrete base components, wherein at least one base component comprises a coffee or tea base component and at least one other component comprises a dairy or soy base component; wherein each component is buffered or stabilized independently and prepared at a first location;
combining the at least two base components with water to make the beverage at a second location; and
packaging the beverage.

2. The method of claim 1, wherein at least one of the premade base components is buffered with at least one of disodium phosphate, potassium citrate, and potassium carbonate.

3. The method of claim 2, wherein the disodium phosphate is present in at least one of the premade components at an amount of about 0.1 to about 1 percent by weight.

4. The method of claim 2, wherein the potassium citrate is present in at least one of the premade components at an amount of about 0.1 to about 1 percent by weight.

5. The method of claim 1, wherein at least one premade component comprises at least one selected from the group consisting of dietary fiber, a vitamin, an omega-3 oils, a fruit extract, an antioxidant, a flavinoid, lycopene, selenium, a beta-carotene, resveratrol, a vegetable extract, and a herbal extracts.

6. The method of claim 1, wherein the at least two premade base components are prepared at least 12 hours before being combined.

7. The method of claim 1, wherein the at least two premade base components are prepared at least 1 week before being combined.

8. The method of claim 1, wherein the beverage comprises water in an amount of about 80 to about 90 percent by weight, a coffee or tea base component in an amount of about 0.5 to about 10 percent by weight, a dairy or soy base component in an amount of about 1 to about 60 percent by weight, and a flavor key in an amount of about 0.1 to about 5 percent by weight.

9. The method of claim 1, wherein the coffee or tea base component includes an encapsulated coffee or tea extract.

10. The method of claim 1, wherein the dairy or soy base component includes a dairy or soy dispersion and a cream mix.

11. The method of claim 1, wherein the beverage is a ready-to-drink beverage.

12. A method of making a beverage, comprising:
providing at least two premade discrete base components, wherein at least one base component comprises a coffee or tea base component; wherein each component is buffered independently and prepared at a first location; and
combining the at least two base components to make a beverage at a second location.

13. The method of claim 12, wherein the at least two premade base components are prepared at least 12 hours before being combined with water.

14. The method of claim 12, wherein the at least two premade base components are prepared at least 3 days before being combined with water.

15. The method of claim 12, wherein the beverage comprises water in an amount of about 80 to about 90 percent by weight, a coffee or tea base component in an amount of about 0.5 to about 10 percent by weight, a dairy or soy base component in an amount of about 1 to about 60 percent by weight, and a flavor key in an amount of about 0.1 to about 5 percent by weight.

16. The method of claim 12, wherein the coffee or tea base component includes an encapsulated coffee or tea extract.

17. The method of claim 12, wherein the dairy or soy base component includes a dairy or soy dispersion and a cream mix.

18. The method of claim 12, wherein the beverage is a ready-to-drink beverage.

19. The method of claim 12, wherein at least one premade component comprises at least one selected from the group consisting of dietary fiber, a vitamin, an omega-3 oils, a fruit extract, an antioxidant, a flavinoid, lycopene, selenium, a beta-carotene, resveratrol, a vegetable extract, and a herbal extracts.

20. The method of claim 12, wherein at least one of the components is buffered with at least one of disodium phosphate, potassium citrate, and potassium carbonate.

21. The method of claim 20, wherein the disodium phosphate is present in at least one of the base components at an amount of about 0.1 to about 1 percent by weight.

22. The method of claim 20, wherein the potassium citrate is present in at least one of the base components at an amount of about 0.1 to about 1 percent by weight.

23. A method of making a beverage, comprising:
receiving at a first location two base components, wherein at least one base component comprises a coffee or tea base component and at least one other component comprises a dairy or soy base component;
wherein each component has been buffered or stabilized independently and prepared at a second location;
combining the at least two base components with water to make the beverage at the first location; and
packaging the beverage.

24. The method of claim 23, wherein at least one of the premade base components is buffered with at least one of disodium phosphate, potassium citrate, and potassium carbonate.

25. The method of claim 23, wherein the disodium phosphate is present in at least one of the premade components at an amount of about 0.1 to about 1 percent by weight.

26. The method of claim 23, wherein the potassium citrate is present in at least one of the premade components at an amount of about 0.1 to about 1 percent by weight.

27. The method of claim 23, wherein at least one premade component comprises at least one selected from the group consisting of dietary fiber, a vitamin, an omega-3 oils, a fruit extract, an antioxidant, a flavinoid, lycopene, selenium, a beta-carotene, resveratrol, a vegetable extract, and a herbal extracts.

28. The method of claim 23, wherein the at least two premade base components are prepared at least 12 hours before being combined.

29. The method of claim 23, wherein the at least two premade base components are prepared at least 1 week before being combined.

30. The method of claim 23, wherein the beverage comprises water in an amount of about 80 to about 90 percent by weight, a coffee or tea base component in an amount of about 0.5 to about 10 percent by weight, a dairy or soy base component in an amount of about 1 to about 60 percent by weight, and a flavor key in an amount of about 0.1 to about 5 percent by weight.

31. A system for making a beverage comprising:
a component combining system configured to receive at a first location two base components, wherein at least one base component comprises a coffee or tea base component and at least one other component comprises a dairy or soy base component;
wherein each component has been buffered or stabilized independently and prepared at a second location;
wherein the component combining system is configured to combine the at least two base components with water and package the beverage.

32. The system of claim 31, wherein at least one of the premade base components is buffered with at least one of disodium phosphate, potassium citrate, and potassium carbonate.

33. The system of claim 31, wherein the disodium phosphate is present in at least one of the premade components at an amount of about 0.1 to about 1 percent by weight.

34. The system of claim 31, wherein the potassium citrate is present in at least one of the premade components at an amount of about 0.1 to about 1 percent by weight.

35. The system of claim 31, wherein at least one premade component comprises at least one selected from the group consisting of dietary fiber, a vitamin, an omega-3 oils, a fruit extract, an antioxidant, a flavinoid, lycopene, selenium, a beta-carotene, resveratrol, a vegetable extract, and a herbal extracts.

36. The system of claim 31, wherein the at least two premade base components are prepared at least 12 hours before being combined.

37. The system of claim 31, wherein the at least two premade base components are prepared at least 1 week before being combined.

38. The system of claim 31, wherein the beverage comprises water in an amount of about 80 to about 90 percent by weight, a coffee or tea base component in an amount of about 0.5 to about 10 percent by weight, a dairy or soy base component in an amount of about 1 to about 60 percent by weight, and a flavor key in an amount of about 0.1 to about 5 percent by weight.
